(19) United States
(12) Patent Application Publication
(10) Pub. No.: US 2025/0105306 A1
(43) Pub. Date: Mar. 27, 2025

(54) INTERSPERSED BOND LAYER IN CURRENT COLLECTOR

(71) Applicant: Apple Inc., Cupertino, CA (US)

(72) Inventor: Ulrich A. Bonne, Sunnyvale, CA (US)

(21) Appl. No.: 18/886,663

(22) Filed: Sep. 16, 2024

Related U.S. Application Data
(60) Provisional application No. 63/585,870, filed on Sep. 27, 2023.

(51) Int. Cl. H01M 4/78; H01M 10/058

(52) U.S. Cl. CPC H01M 4/78; H01M 10/058

(57) ABSTRACT

A battery including a first battery cell, a second battery cell, a current collector electrically connected between the first and second battery cells, where the current collector may define a plurality of apertures, and an electrically conductive adhesive disposed in each aperture of the plurality of apertures.

### CROSS-REFERENCE TO RELATED APPLICATION

This application claims the benefit of U.S. Provisional Patent Application No. 63/585,870, filed on Sep. 27, 2023, which is herein incorporated by reference in its entirety for all purposes.

### BACKGROUND OF THE INVENTION

As electronic devices increase in functionality there is a commensurate increased demand for energy stored in the battery cells that are used to power the electronic devices. Simultaneously, the size and weight constraints of electronic devices limit the number and size of the battery cells integrated in the electronic device. Accordingly, there is a need to maximize the energy density of a battery pack. Additionally, one goal of device designers is to minimize the shape and thickness of the device.

### BRIEF SUMMARY

One aspect of the disclosure provides for a battery including a first battery cell, a second battery cell, a current collector electrically connected between the first and second battery cells, where the current collector may define a plurality of apertures, and an electrically conductive adhesive disposed in each aperture of the plurality of apertures.

Implementations may include one or more of the following features. The first battery cell may include a first conductive layer, the second battery cell may include a second conductive layer, and the current collector electrically connects the first conductive layer to the second conductive layer. The first conductive layer may be an anode of the first battery cell and where the second conductive layer is an anode of the second battery cell. The first conductive layer may be a cathode of the first battery cell and where the second conductive layer is a cathode of the second battery cell. The first conductive layer may be a cathode of the first battery cell and where the second conductive layer is an anode of the second battery cell. At least one aperture of the plurality of apertures may include a geometric shape. The at least one aperture may include a rectangular shape. At least one aperture of the plurality of apertures may include an irregular shape. The current collector may include a first current collector surface coupled to the first battery cell and a portion of the electrically conductive adhesive is positioned between the first current collector surface and the first battery cell. The current collector may include a first current collector surface coupled to the first battery cell and the battery may be free of electrically conductive adhesive between the first current collector surface and the first battery cell. The electrically conductive adhesive surface may include a first adhesive surface contacting the first battery cell; and the first adhesive surface is flush with the first current collector surface.

One aspect of the disclosure provides for a battery including a first battery cell, a second battery cell, a current collector positioned between the first and second battery cells, where the current collector may define a plurality of apertures, and an electrically conductive adhesive disposed in each aperture of the plurality of apertures, where the electrically conductive adhesive electrically couples the first battery cell and the second battery cell.

Implementations may include one or more of the following features. At least one aperture of the plurality of apertures may include a geometric shape. The at least one aperture may include a rectangular shape. At least one aperture of the plurality of apertures may include an irregular shape. The current collector may include a first current collector surface coupled to the first battery cell and a portion of the electrically conductive adhesive is positioned between the first current collector surface and the first battery cell. The current collector may include a first current collector surface coupled to the first battery cell and the battery is free of electrically conductive adhesive between the first current collector surface and the first battery cell.

One aspect of the disclosure provides for a method of forming a battery including providing a first battery cell, providing a second battery cell, positioning an adhesive in each aperture of a plurality of apertures defined in a current collector, and electrically connecting the current collector between the first and second battery cells.

Implementations may include one or more of the following features. The method further may include forming the plurality of apertures in the current collector. The method further may include, prior to electrically connecting the current collector between the first and second battery cells, removing a release layer from the current collector.

### BRIEF DESCRIPTION OF THE DRAWINGS

FIG. 1A illustrates a cross-sectional side view of a battery cell stack according to one embodiment of the invention.

FIG. 1B illustrates a cross-sectional top view of the battery cell stack along the cross-sectional plane 1B-1B.

FIG. 2 illustrates a cross-sectional top view of a battery cell stack according to one embodiment of the invention.

FIG. 3 illustrates a cross-sectional top view of a battery cell stack according to one embodiment of the invention.

FIG. 4 illustrates a step in the manufacturing of a battery cell stack according to one embodiment of the invention.

FIG. 5 illustrates a step in the manufacturing of a battery cell stack according to one embodiment of the invention.

FIG. 6 illustrates an example flowchart depicting a method of manufacturing a battery cell stack according to one embodiment of the invention.

### DETAILED DESCRIPTION OF THE INVENTION

The present disclosure is directed to battery cell stacks having a common perforated current collector positioned in between adjacent battery cells arranged in a stacked configuration. The perforated current collector may define a plurality of apertures and may include an electrically conductive adhesive disposed within each of the apertures. The conductive adhesive may electrically couple the two battery cells together and simultaneously couple each cell to the common current collector. In one example, an anode of a first battery is coupled to an anode of a second battery via the perforated common current collector. In another example, an anode of a first battery cell is coupled to a cathode of a second battery cell via the perforated common current collector. The perforated common current collector enables increased volumetric energy density of the battery by 1) decreasing the size and number of current collectors within the battery as compared to conventional configurations and 2) eliminating a separate layer dedicated to bonding material.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

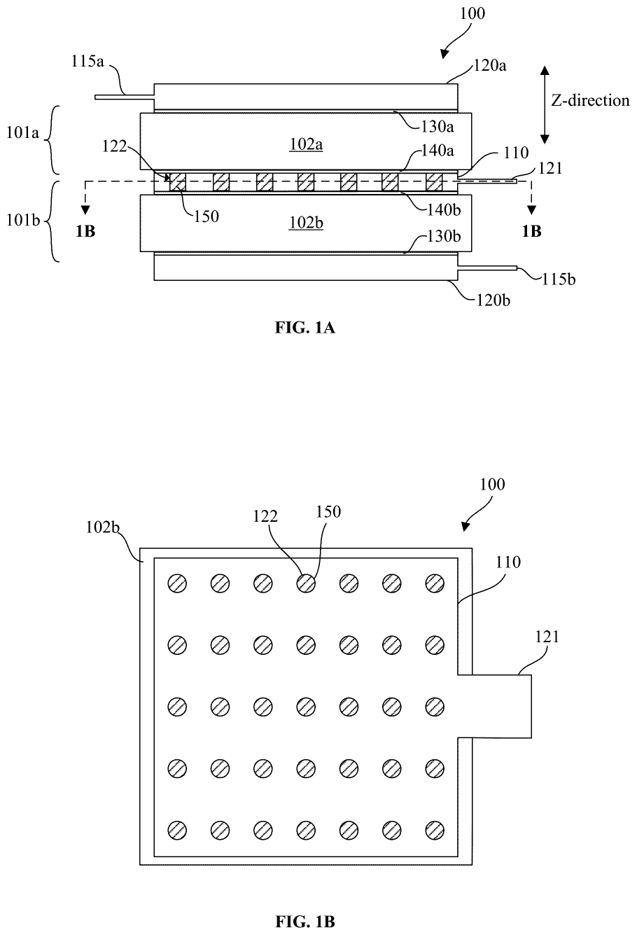

FIG. 1A depicts an example battery cell stack 100, according to embodiments of the disclosure. As would be readily understood, the components comprising the battery cell stack 100 are not shown at any particular scale and, instead, are intended merely for illustration. The battery cell stack 100 illustrates first and second battery cells 101a, 101b, respectively, stacked on top of, and electrically coupled to each other. Other embodiments may include three, four, five or more battery cells in the battery cell stack. First battery cell 101a may include a first electrochemical cell 102a coupled between a first anode conductive layer 140a and a first cathode conductive layer 130a, which are each generally referred to herein as conductive layers. Similarly, second battery cell 101b may include a second electrochemical cell 102b coupled between a second anode conductive layer 140b and a second cathode conductive layer 130b.

The battery cell stack 100 may include a perforated common current collector 110 that includes a plurality of apertures 122 filled with an electrically conductive adhesive 150. The electrically conductive adhesive 150 may electrically couple the first anode conductive layer 140a to the second anode conductive layer 140b, and may couple both of the first anode layer and the second anode layer to the common anode current collector such that the first battery cell 101a is coupled in parallel with the second battery cell 101b. Battery cell stack 100 may further include outer cathode current collectors 120a, 120b that can be used with common current collector 110 to couple the battery cell stack 100 to a load.

The adhesive 150 may be a paste, glue, solder, epoxy, pressure-sensitive adhesive (e.g., an elastomeric tape) or any other suitable material. As will be discussed further below, the adhesive 150 may be cured by heat, moisture, ultra-violet (UV) radiation, thermal radiation or other suitable technique. The adhesive 150 may be filled with an electrically conductive material, (e.g., particulates) such as for example nickel, silver, or the like. In further embodiments a solder, a solder paste, or similar material may be used in place of adhesive 150 and may be reflowed to form the electrical connections. In one example, the adhesive 150 may be a unit of solder (e.g., a ball or flake of solder) positioned in each of the apertures 122 that is later heated up (e.g., through a laser heater or the like) until the solder melts. The battery cell 101a may be positioned on the current collector 110 after the solder is melted.

An example current flow path for the battery cell stack 100 may include the electrochemical cells 102a, 102b generating electricity and the electricity flowing through the conductive layers 130a, 130b, 140a, 140b through the current collectors 110, 120a, 120b and through the tabs 115a, 115b and 121 to a load (e.g., electric motor, central processing unit, etc.). In particular, for the perforated current collectors 110 the current may flow through conductive layers 140a, 140b, into the electrically conductive adhesive 150 and into current collector 110. The current collector can then conduct the current laterally to tab 121.

The apertures 122 may extend through the entire thickness of the current collector 110 along the Z-direction. The apertures 122 may have any suitable diameter and shape to receive the electrically conductive adhesive 150. For example, the apertures 122 may have a diameter between about 0.01 mm and 10 mm, such as between about 0.02 mm and 9 mm, such as between about 0.03 mm and 8 mm, such as between about 0.04 mm and 7 mm, such as between about 0.05 mm and 6 mm, such as between about 0.06 mm and 5 mm, such as between about 0.07 mm and 4 mm, such as between about 0.08 mm and 3 mm, such as between about 0.09 mm and 2 mm, or about 1 mm. In some embodiments, the diameter of the apertures 122 may be dependent on a viscosity or other characteristic of the adhesive 150. For example, if the adhesive 150 is low viscosity, the diameter of the corresponding apertures 122 may be smaller while, if the adhesive is high viscosity, the diameter may be relatively greater (e.g., 20-1000 times the thickness of the current collector 110).

The apertures 122 may have any suitable spacing between each other along the current collector 110. For example, for apertures 122 having a 1 mm diameter, the apertures may have a pitch between about 1 mm and 10 mm, such as between about 2 mm and 8 mm, such as between about 3 mm and 7 mm, such as between about 4 mm and 6 mm, or such as about 5 mm. In other embodiments, one or more of the current collectors may not define multiple apertures but, instead, define one singular aperture. In yet other embodiments, the current collectors may define apertures along an edge of the current collectors, such as a series of notches or indentations.

The common current collector 110 and the outer current collectors 120a, 120b can be made of any suitable electrically conductive material such as a metal or a non-metal electrically conductive material, such as an electrically conductive polymer or composite. In some instances, the electrically conductive materials used for common current collector 110 may be the same or different than the electrically conductive material used for outer current collectors 120a, 120b. In one embodiment the electrically conductive material can be selected based on its electrochemical compatibility with the adjacent conductive layers e.g., 130a, 130b, 140a, 140b. In some embodiments the electrically conductive material may include one or more of copper, aluminum, stainless steel or carbon (including graphite, graphene and the like).

The current collectors 110, 120a, 120b may have any suitable thickness that provides suitable electrical performance, flexibility, and mechanical stability to prevent failure, such as fusing or breakage of the layers during anticipated usage of the stacked battery 100. In some embodiments, the electrically conductive material can be sufficiently thin to allow for bending and flexing to accommodate expansion anticipated during cycling of the stacked battery, including, for example, up to 10% expansion in the Z-direction. In some embodiments the current collectors 110, 120a, 120b can be a foil that is deposited through plating or a vapor deposition process.

Additionally, in some embodiments, the current collectors 110, 120a, 120b may include combinations of polymer material and electrically conductive materials, such as disposed within a polymer matrix. An example matrix may include a polymer disposed as the matrix material or as part of the matrix material. The matrix may provide a partially insulative design that limits or reduces conductivity along one or more directions while increasing conductivity along one or more other directions. For example, the conductive particulate material may be incorporated within the polymer matrix. The conductive material may include any of the conductive materials previously identified. In embodiments, the conductive material may include one or more of silver, aluminum, copper, stainless steel, and a carbon-containing material. In this way, the current collector 110, 120a, 120b may have a tuned resistivity to provide in-plane directional control for electrical conductivity. For example, the produced current collector 110, 120a, 120b may be configured to provide an in-plane resistivity across a length in the planar direction of the current collector as well as a through-plane resistivity in the Z-direction, which is greater than or about 1×10⁻⁴ ohm-m in embodiments. Additionally, exemplary current collectors 110, 120a, 120b may have an in-plane and through-plane resistivity of between about 1×10⁻³ ohm-m and about 1,000 ohm-m. In other embodiments, more conventional electrical distribution may be employed, where current is transferred along conductive current collectors into and out of the cell.

Each current collector may include a tab or other feature that can be used to electrically couple the current collector to a load. Common current collector 110 includes a common tab 121 and outer current collectors 120a, 120b include first and second tabs 115a, 115b, respectively. In some embodiments, the tabs 121, 115a, 115b may be monolithically formed as an integral part of the current collectors while in other embodiments they may be electrically coupled to a body of the current collector.

The conductive layers 130a, 130b, 140a, 140b may be made of any suitable conductive material, such as an electrically conductive metal. For example, the conductive layers 130a, 130b, 140a, 140b may be a foil made of aluminum, copper, or the like. The conductive layers 130a, 130b, 140a, 140b may be deposited on a respective surface of electrochemical cells 102a, 102b, common current collector 110, and current collector 120b. The material of each of the conductive layers 130a, 130b, 140a, 140b may correspond to the active material of the respective electrochemical cell 102a, 102b that the conductive layer is coupled to. For example, where the conductive layer is coupled to a cathode active material of the electrochemical cell the conductive layer may be aluminum and where the conductive layer is coupled to an anode active material the conductive layer may be copper.

The electrochemical cells 102a, 102b may include one or more internal components (not shown in FIGS. 1A and 1B for clarity). For example, the electrochemical cells 102a, 102b may each include one or more of a cathode active material, anode active material, and a separator. In some embodiments, the cathode and anode active materials may be separated from each other by the separator, each of which is described in more detail below.

In some embodiments the cathode active material may include aluminum, stainless steel, or other suitable metals, as well as a non-metal material including a polymer. For example, the cathode active material may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell. The anode active material may include copper, stainless steel, or any other suitable metal, as well as a non-metal material including a polymer. For example, the anode active material may be silicon, graphite, carbon, a tin alloy, lithium metal, a lithium-containing material, such as lithium titanium oxide (LTO), or other suitable materials that can form an anode in a battery cell.

The active materials may additionally include an amount of electrolyte in a completed cell configuration. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example. In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities.

In some embodiments the common current collector 110 with the distributed adhesive 150 regions may accommodate a thermal expansion mismatch or differential heating in the batteries that may cause in-plane stress within the common current collector. More specifically, the distributed bond layer may be easier to deform and may accommodate relative movement between each battery resulting in a more reliable interconnect than a uniform bond layer.

FIG. 1B depicts an example cross-section of the battery cell stack shown in FIG. 1A along the cross-sectional plane 1B-1B. As shown in FIG. 1B, the apertures 122 may include any suitable shape, as described in more detail below. For example, FIG. 1B depicts the apertures 122 having a circular shape, however, in other embodiments the apertures may have other shapes.

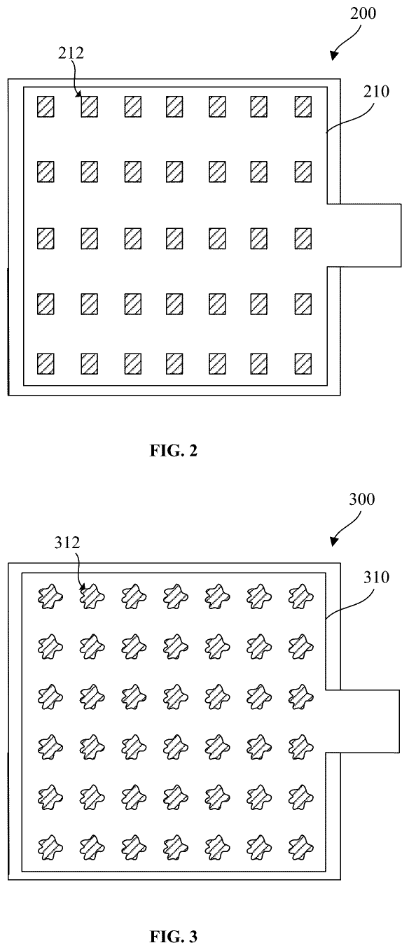

FIG. 2 depicts a cross-section of a battery cell stack 200 that may be taken in a similar location as the cross-section as shown in FIG. 1B. It is understood that features ending in like reference numerals as features discussed above are similar, except as noted below. The current collector 210 may define the apertures 212 as rectangular shapes. In other embodiments, the apertures may include other geometric shapes, such as triangular, hexagonal, or the like.

FIG. 3 depicts a cross-section of battery cell stack 300 that may be taken in a similar location as the cross-section as shown in FIG. 1B. It is understood that features ending in like reference numerals as features discussed above are similar, except as noted below. The current collector 310 may define the apertures 312 to include an irregular shape. In other embodiments, the apertures may include other irregular shapes. For example, the current collectors may define the apertures to have a serpentine pattern.

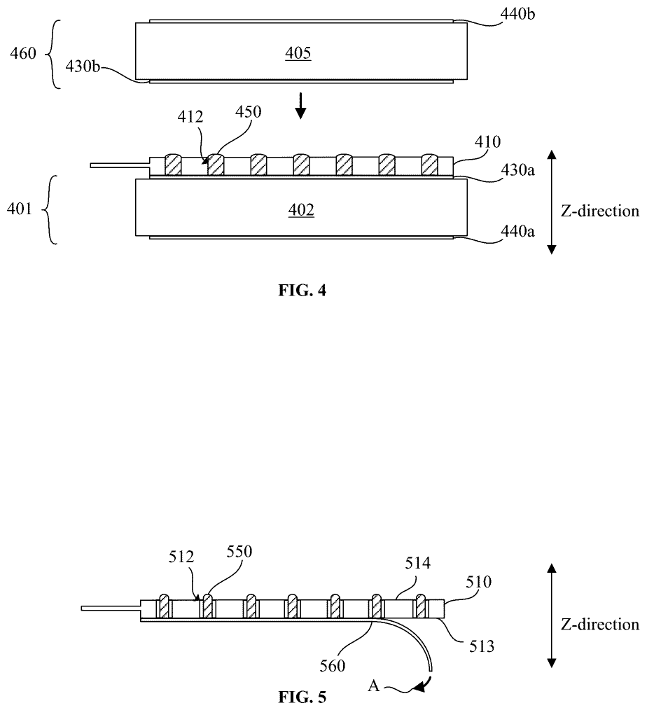

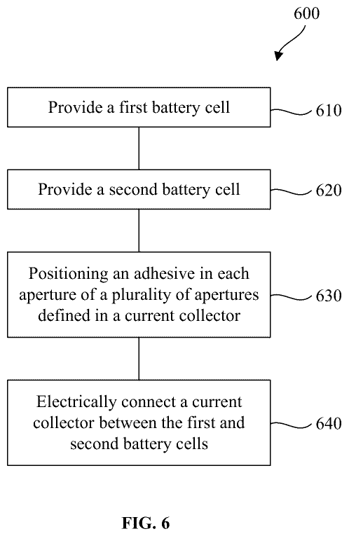

FIGS. 4 and 5 depict example methods of manufacturing a battery cell stack. For ease of discussion and illustration, certain components may be omitted, however it is understood that there may be more components for each battery cell stack, as shown above.

Turning to FIG. 4, a battery cell 401 is depicted. It is understood that features ending in like reference numerals as features discussed above are similar, except as noted below. The battery cell 401 may be formed by coupling the electrochemical cell 402 between the conductive layers 430a, 440a. This configuration of components may form a single battery cell 401, however, in other embodiments, this configuration may form a substrate that is cut up to form a plurality of battery cells.

A perforated current collector 410 may be positioned on the conductive layer 430a. An adhesive 450 may fill the apertures 412 to couple the current collector 410 to the conductive layer 430a. The adhesive 450 may fill the apertures 412 such that the adhesive 450 may have a thickness along the Z-direction greater than a thickness of the current collector 410. In other words, the adhesive 450 may fill the apertures 412 such that the adhesive 450 overflows the current collector 410. In this manner, when coupling the conductive layer 430b of a second battery cell 460 (e.g., comprising an electrochemical cell 405 coupled between conductive layers 430b, 440b) to the current collector 410, the excess portions of the adhesive 450 may spread between the conductive layer 430b and current collector 410. This overflow of adhesive 450 may ensure that the adhesive 450 contacts the current collector 410 within the aperture 412 as well as ensuring that the adhesive 450 contacts the conductive layer 430b. In some embodiments the adhesive 450 may be dispensed within each aperture 412, may be stencil printed, may be pre-deposited and transferred via a carrier tape or other suitable process.

In other embodiments, the current collector may be coupled to the battery cell through other means. For example, FIG. 5 depicts a current collector 510 coupled with a release layer (or carrier tape) 560. It is understood that features ending in like reference numerals as features discussed above are similar, except as noted below. The surface of the release layer 560 coupled with the current collector 510 may be treated with silicone or another suitable release agent to allow for the release layer 560 to be easily removable from the current collector 510. Prior to coupling the current collector 510 with a battery cell (e.g., similar to the battery cell 401, shown in FIG. 4), the release layer 560 may be decoupled from a surface 513 of the current collector 510. Specifically, an end of the release layer 560 may be pulled along the arrow A to remove the release layer 560 from the current collector 510. Once the release layer 560 is removed, the current collector 510 may be coupled to the battery cell via the adhesives 550.

The apertures 512 may be partially filled with the adhesive 550 prior to the current collector 510 coupling with any other component. The adhesive 550 may partially fill the apertures 512 such that a portion of the current collector 510 defining the apertures 512 are free of the adhesive 550 prior to other components coupling to the current collector 510, such as other conductive layers (similar to the conductive layer 430b, shown in FIG. 4). That is, in some embodiments the adhesive 550 may have an outer periphery that is smaller than an inner periphery of the apertures 512, allowing the adhesive to compress and expand within the aperture when compressed between two battery cells. The adhesive 550 may contact the current collector 510 enough to prevent the adhesive 550 from decoupling with the current collector 510 when the release layer 560 is decoupled from the current collector 510. The adhesive 550 may have a thickness greater along the Z-direction than the current collector 510 to ensure that, when another conductive layer couples with the surface 514 of the current collector 510, the conductive layer would contact the adhesive 550. Further, when the conductive layer couples with the surface 514, the adhesive 550 may compress along the Z-direction and spread within the aperture 512 such that the adhesive 550 may fill the apertures 512 to further contact the current collector 510 without overflowing, or minimally overflowing over the current collector 510. For example, the top and bottom surfaces of the adhesive 550 (e.g., along the Z-direction) may be flush, or co-planar, with the top and bottom surfaces of the current collector 510 (e.g., along the Z-direction).

In some embodiments, the surfaces of the various components of the battery stack may be cleaned to remove debris along the surfaces of the components and ensure maximal contact surface therebetween. In some embodiments, the coupling of the various components can be performed under a vacuum to ensure that there is no air between the current collectors and cell. In some embodiments, pressing the conductive layers and current collectors may include applying sufficient pressure that at least one of the components partially deforms to ensure that there is maximal contact therebetween. Once the components are coupled together, the adhesives may be cured through exposure to elevated temperature, moisture, UV radiation, or heat radiation.

FIG. 6 depicts an example flow chart 600 depicting a method of manufacturing the battery cell stack 100. In step 610, a first battery cell is provided. For example, a battery cell 101a may be provided. The battery cell 101a may be coupled to one or more other components, such as the current collector 120a. In step 620, a second battery cell is provided. For example, a battery cell 101b may be provided. The battery cell 101b may be coupled to one or more other components, such as the current collector 120b. In step 630, an adhesive may be positioned in each aperture of a plurality of apertures defined in a current collector. For example, an adhesive 150 may be positioned in each aperture 122 of a plurality of apertures 122 defined in a current collector 110. In some embodiments, the plurality of apertures 122 may be formed in the current collector 110 prior to this step (e.g., through pressing, puncturing, cutting, or the like). In other embodiments, a release layer (e.g., the release layer 560, as shown in FIG. 5) may be decoupled from the current collector 110 after the adhesive 150 is positioned in the apertures 122. In step 640, a current collector may be electrically connected between the battery cells. For example, the current collector 110 may be coupled between the battery cell 101a and the battery cell 101b such that electricity may flow between the battery cells 101a, 101b.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery comprising:
a first battery cell;
a second battery cell;
a current collector electrically connected between the first and second battery cells, wherein the current collector defines a plurality of apertures; and
an electrically conductive adhesive disposed in each aperture of the plurality of apertures.

2. The battery of claim 1, wherein:
the first battery cell includes a first conductive layer;
the second battery cell includes a second conductive layer; and
the current collector electrically connects the first conductive layer to the second conductive layer.

3. The battery of claim 2, wherein the first conductive layer is an anode of the first battery cell and wherein the second conductive layer is an anode of the second battery cell.

4. The battery of claim 2, wherein the first conductive layer is a cathode of the first battery cell and wherein the second conductive layer is a cathode of the second battery cell.

5. The battery of claim 2, wherein the first conductive layer is a cathode of the first battery cell and wherein the second conductive layer is an anode of the second battery cell.

6. The battery of claim 1, wherein at least one aperture of the plurality of apertures includes a geometric shape.

7. The battery of claim 6, wherein the at least one aperture includes a rectangular shape.

8. The battery of claim 1, wherein at least one aperture of the plurality of apertures includes an irregular shape.

9. The battery of claim 1, wherein:
the current collector includes a first current collector surface coupled to the first battery cell; and
a portion of the electrically conductive adhesive is positioned between the first current collector surface and the first battery cell.

10. The battery of claim 1, wherein:
the current collector includes a first current collector surface coupled to the first battery cell; and
the battery is free of electrically conductive adhesive between the first current collector surface and the first battery cell.

11. The battery of claim 10, wherein:
the electrically conductive adhesive surface includes a first adhesive surface contacting the first battery cell; and
the first adhesive surface is flush with the first current collector surface.

12. A battery comprising:
a first battery cell;
a second battery cell;
a current collector positioned between the first and second battery cells, wherein the current collector defines a plurality of apertures; and
an electrically conductive adhesive disposed in each aperture of the plurality of apertures, wherein the electrically conductive adhesive electrically couples the first battery cell and the second battery cell.

13. The battery of claim 12, wherein at least one aperture of the plurality of apertures includes a geometric shape.

14. The battery of claim 13, wherein the at least one aperture includes a rectangular shape.

15. The battery of claim 12, wherein at least one aperture of the plurality of apertures includes an irregular shape.

16. The battery of claim 12, wherein:
the current collector includes a first current collector surface coupled to the first battery cell; and
a portion of the electrically conductive adhesive is positioned between the first current collector surface and the first battery cell.

17. The battery of claim 12, wherein:
the current collector includes a first current collector surface coupled to the first battery cell; and
the battery is free of electrically conductive adhesive between the first current collector surface and the first battery cell.

18. A method of forming a battery comprising:
providing a first battery cell;
providing a second battery cell;
positioning an adhesive in each aperture of a plurality of apertures defined in a current collector; and
electrically connecting the current collector between the first and second battery cells.

19. The method of claim 18, further comprising forming the plurality of apertures in the current collector.

20. The method of claim 18, further comprising, prior to electrically connecting the current collector between the first and second battery cells, removing a release layer from the current collector.
